(19) United States
(12) Patent Application Publication
(10) Pub. No.: US 2026/0018635 A1
(43) Pub. Date: Jan. 15, 2026

(54) LOAD REDUCTION LIMITATION IN HIGH-TEMPERATURE OPERATION

(71) Applicant: Robert Bosch GmbH, Stuttgart (DE)

(72) Inventors: Jonas Breitinger, Stuttgart (DE); Daniel Seidl, Stuttgart (DE); Mark Hellmann, Korntal (DE)

(21) Appl. No.: 18/880,409

(22) PCT Filed: Jul. 10, 2023
(86) PCT No.: PCT/EP2023/069016

§ 371 Date: Dec. 31, 2024

(30) Foreign Application Priority Data
Jul. 14, 2022 (DE) 10 2022 207 195.6

(51) Int. Cl. H01M 8/04701; H01M 8/0432; H01M 8/04858

(52) U.S. Cl. CPC H01M 8/04723; H01M 8/04358; H01M 8/04932; H01M 2250/20

(57) ABSTRACT

The present invention relates to a method for operating a fuel cell (1) of a fuel cell system (2) for a vehicle. According to the method, a predetermined load reduction is implemented in stages so that, combined with cooling of the fuel cell (1), unacceptable operating conditions, which can, for example, lead to increased wear of the fuel cell (1), are avoided. The invention also relates to a fuel cell system (2) for a vehicle.

### BACKGROUND

The present invention relates to a method of operating a fuel cell of a fuel cell system for a vehicle, in particular for a land vehicle, marine vehicle, aircraft, or the like. The invention also relates to a fuel cell system for a vehicle.

Hydrogen-based PEM fuel cell systems are considered to be the mobility concept of the future, because they only emit water as exhaust gas and enable fast fueling times.

In vehicles, the heat that can be dissipated is limited by the low temperature level of the fuel cell and the limited radiator surface. Normal operating temperatures of fuel cells are around 60° C. To prevent damage to the fuel cell, around 90° C. is permissible. In some operating conditions, such as when a motor vehicle is traveling uphill with a high power demand and low flow speed of the radiator, this results in a thermal limitation. In the event of thermal limitation, the heat produced by the fuel cells, which are sometimes combined into a fuel cell stack, can no longer be fully dissipated. In extreme cases, the performance of the fuel cells of the fuel cell stack must then be reduced, which is referred to as thermal derating.

Methods for operating fuel cells are known in which the operating temperature is raised from typically around 60° C. to up to 90° C. in order to avoid or delay derating. The greater temperature difference to the surroundings allows for an increase in the heat flow that can be dissipated with a given radiator. If the operating pressure is raised at the same time, robust operation with sufficient membrane wetting can be ensured at high current densities.

Nevertheless, cases can occur in which the system temperature has increased due to long full-load operation with insufficient cooling capacity and the power requirement is then drastically reduced. Such a case can occur, for example, when a vehicle stops spontaneously after travelling uphill, especially at relatively high surrounding temperatures and low inflow velocities.

Due to the thermal inertia of fuel cells, power reduction can generally be much faster than temperature reduction. Thus, the fuel cell system may fall into a very unfavorable state where, at a relatively low load, there is a relatively high operating temperature of the fuel cell. Such an operating condition is hereinafter referred to as an “unstable operating condition.”

In relatively low load operation, a collision of two operating limits may occur. If the gas supply is set in this way to ensure sufficient moisture of the membrane of the fuel cell, the flow rate in the channel can become so slow that sufficient discharge of liquid water from the fuel cell cannot be guaranteed. The discrepancy between the two operating limits increases as the system temperature rises. Stable intermittent operation of the fuel cell allows the operating range to be extended to lower loads.

If even lower loads are to be set at high temperatures at the coolant outlet, an unstable operating condition may sometimes no longer be avoided, even with intermittent operation. In this case, the two limits are so far apart that intermittent operation with typical air systems is no longer feasible. Depending on the combination of pressure and stoichiometry, either flooding due to insufficient liquid water discharge or excessive drying out of the membrane can occur. A stable, for example stationary, operating condition of the fuel cells is thus not guaranteed.

### SUMMARY

According to a first aspect of the invention, a method for operating a fuel cell of a fuel cell system for a vehicle, particularly for a land vehicle, marine vehicle, aircraft, or the like, is provided. The method comprises:
operating the fuel cell with a first load at a first temperature by a control device of the fuel cell system,
receiving a load requirement for operating the fuel cell with a second load by the control device, wherein the second load is less than the first load,
selectively reducing the load of the fuel cell to a third load by the control device, wherein the third load is less than the first load and greater than the second load,
cooling the fuel cell to a second temperature, and
reducing the load of the fuel cell to the second load by the control device.

Operating a fuel cell can also be understood within the scope of the invention as operating several or all of the fuel cells of a fuel cell stack. For the sake of clarity, only one fuel cell is referred to in the following, wherein several or all fuel cells may also be meant.

When performing the method, the fuel cell is initially operated by means of the control device in such a way that an initial situation is created which, in conventional methods for operating fuel cells, would normally lead to unstable or critical operating conditions of the fuel cell if a predetermined, relatively large load reduction were applied to the second load. Such an initial state can be achieved, for example, when a fully loaded motor vehicle is traveling uphill for a long time at relatively high outside temperatures.

In this initial state, the first load is applied, which can range from 80% to 100% of the fuel cell's capacity, for example. For example, a load may be set via a current, electrical power, voltage level, or hydrogen supply. In the following, the idea according to the invention is described by way of an example using a current. For example, the first load may be between 450 A and 500 A. Preferably, the first load is around 480 A. In this context, the first load is transmitted to the control device as a load requirement to operate the fuel cell, for example.

In addition, the fuel cell has the first temperature in the initial state. For example, the first temperature may be between 80% and 100% of a maximum allowable operating temperature of the fuel cell. For example, the first temperature may be between 75° C. and 90° C. Preferably, the first temperature is around 90° C. The control device preferably determines the temperature values of the fuel cell continuously or intermittently. For example, the first temperature may be determined, for example, by measuring using a temperature sensor, which is arranged, for example, at a coolant outlet of a fuel cell stack and is configured to measure a temperature of the coolant exiting through the coolant outlet, and/or by calculating or determining from one or more characteristic maps of the fuel cell system.

The control device now receives a load requirement to operate the fuel cell with the second load that is less than the first load. In conventional methods, the control device would reduce the load of the fuel cell to the second load and operate the fuel cell with the second load until a changed load requirement is received. Nevertheless, operating the fuel cell with the second load may result in an unstable operating condition of the fuel cell due to the relatively high first temperature of the fuel cell. An unstable operating condition is understood to mean an operating condition in which the functions of the fuel cell, for example sufficient membrane moisture, sufficient water drainage or the like, are not guaranteed. As a result, the fuel cell may be subject to accelerated aging or may no longer function properly. For example, a plausible second load may be between 40 A and 60 A. Preferably, the second load is around 50 A.

To avoid such an unstable operating condition of the fuel cell, the control device reduces the load of the fuel cell to the third load, which is between the first load and the second load. In other words, the load reduction of the fuel cell is reduced to a lower level than specified by the load requirement, for example by a driver of a motor vehicle. The third load is preferably selected such that when operating the fuel cell with the third load at the first temperature, a critical operating condition is avoided. For example, the third load may be between 100 A and 200 A. Preferably, the third load is around 150 A.

By operating the fuel cell with the third load, cooling of the fuel cell is facilitated. According to the invention, active cooling of the fuel cell, for example by a blower, a cooled coolant or the like, may additionally be provided. The reduced load thus cools the fuel cell to the second temperature. For example, the second temperature may be between 50° C. and 70° C. Preferably, the second temperature is around 60° C.

When the fuel cell has cooled to the second temperature, the load of the fuel cell is reduced to the second load by the control device. Cooling the fuel cell to the lower second temperature ensures that the fuel cell can be safely operated with the second load.

A method according to the invention for operating a fuel cell of a fuel cell system for a vehicle has the advantage over conventional methods that safe operation of the fuel cell is ensured by simple means as well as in a cost-efficient manner. By delaying the load reduction from the first load to the second load via the third load, the fuel cell can be cooled to a temperature at which the load requirement for operating the fuel cell with the second load can be safely implemented. Thus, sufficient moisture of the membrane as well as sufficient liquid removal from the fuel cell are always ensured. In this way, operational reliability of the fuel cell system, for example the fuel cells of the fuel cell system, can be increased and wear of the fuel cell system, for example the fuel cells of the fuel cell system, can be reduced.

According to a preferred further development of the invention, a method may provide that the fuel cell is operated at the first load and the first temperature in a stationary operating condition or a stable intermittent operating condition. With these operating conditions, sufficient moisture of the membrane as well as sufficient liquid removal from the fuel cell are always ensured. This has the advantage of ensuring a high level of operational safety and low wear when operating the fuel cell with simple means and in a cost-effective manner.

According to the invention, it is preferred that such a second load is received that the fuel cell would be operating at the first temperature and the second load in an unstable operating condition. In the case of such a load requirement for the second load, the advantages of the method according to the invention compared with methods according to the prior art are particularly advantageous. While the fuel cell is operated in an unstable operating condition according to the prior art, this operating condition can be avoided by reducing to the third load and then reducing to the second load only after the second temperature has been reached. This has the advantage of ensuring a high level of operational safety and low wear when operating the fuel cell with simple means and in a cost-effective manner.

It is also preferable to reduce the load in a sudden, gradual or sudden stepwise or gradual stepwise manner. In the context of the invention, a sudden reduction of the load is understood to mean an abrupt reduction of the load in a jump to the third load. For example, a gradual reduction reducing of the load to the third load may be linear, progressive, and/or degressive. A stepwise sudden reduction is understood to mean a multi-stage abrupt reduction of the load to the third load, in which load conditions are temporarily kept constant between reduction jumps, for example in order to carry out a further reduction only after the fuel cell has cooled down to a certain extent in order to avoid an unstable operating condition. A stepwise gradual reduction reducing is understood to mean gradual reduction in which load conditions are kept constant between the reduction phases. Alternatively, the reduction of the load may also be carried out as a combination of two or more of these variants. The advantage of this is that that the load can be reduced as required with simple means and in a cost-effective manner. High operational safety and low wear are thus ensured when operating the fuel cell.

In a particularly preferred embodiment of the invention, a method may provide that the targeted reduction of the load is carried out such that the fuel cell is operated at least temporarily in a stable intermittent operating condition at a transition to an unstable operating condition. In this case, it is preferred that the operation of the fuel cell in an unstable operating condition is avoided or only tolerated for a very short time. Reducing the load in this way ensures stable operation of the fuel cell with a particularly low load, so that the cooling rate of the fuel cell is particularly high. This has the advantage that the reduction to the second load can be carried out particularly quickly with simple means and in a cost-effective manner due to the relatively high cooling rate.

Preferably, the fuel cell is operated in a stationary operating condition or in a stable intermittent operating condition when the second temperature is reached. In order to have a buffer to an unstable operating condition as wide as possible, the fuel cell is operated in the stationary operating condition when the second temperature is reached. If the second temperature is also selected particularly low, the fuel cell can be operated in the stationary operating condition after the load has been reduced to the second load. In order to reduce the load to the second load as quickly as possible, the fuel cell is operated in the stable intermittent operating condition when the second temperature is reached. This has the advantage that operational reliability of the fuel cell system can be increased and/or time required to carry out the method can be reduced by simple means and in a cost-effective manner.

According to a preferred embodiment of the invention, the fuel cell is cooled to such a second temperature such that the fuel cell is operated at the second load in a stationary operating condition or in a stable intermittent operating condition. This has the advantage that operational reliability of the fuel cell system can be increased and/or time required to carry out the method can be reduced by simple means and in a cost-effective manner.

A load difference between the second load and a higher load, with which the fuel cell is operated during the performance of the method, is particularly preferably used for active cooling of the fuel cell. For this purpose, the fuel cell system preferably comprises a cooling device or is coupled to a cooling device. The load requirement on the second load specifies a target state to be achieved by the fuel cell. As the fuel cell is operated at a higher load than the second load when the method according to the invention is carried out, the fuel cell generates more electrical energy than required. This excess electrical energy should be consumed to avoid overloading the system. Active cooling to cool the fuel cell is particularly suitable for this purpose, as the cooling rate of the fuel cell can be increased in this way and thus the time required to carry out the method can be reduced. This has the advantage of improving operational reliability and cost-effectiveness when operating the fuel cell with simple means and in a cost-effective manner.

According to a second aspect of the invention, a fuel cell system is provided for a vehicle, in particular a land vehicle, marine vehicle, aircraft, or the like. The fuel cell system has a fuel cell and a control device for controlling the fuel cell. According to the invention, the control device is configured to perform a method according to the invention.

According to the invention, the fuel cell system may comprise a plurality of fuel cells, which can be controlled individually, in groups or all together by the control device. The fuel cells are preferably combined to form a fuel cell stack. Preferably, the fuel cells are arranged in a cell housing of the fuel cell system. The control device is preferably arranged in a separate control housing.

The fuel cell system according to the invention has all the advantages that have already been described for a method of operating a fuel cell of a fuel cell system according to the first aspect of the invention. Accordingly, the fuel cell system according to the invention has the advantage over conventional fuel cell systems that safe operation of the fuel cell is ensured by simple means and in a cost-effective manner. By delaying the load reduction from the first load to the second load via the third load, the fuel cell can be cooled to a temperature at which the load requirement for operating the fuel cell with the second load can be safely implemented. This ensures that there is always sufficient moisture in the membrane and sufficient fluid drainage from the fuel cell. In this way, operational reliability of the fuel cell system, for example the fuel cells of the fuel cell system, can be increased and wear of the fuel cell system, for example the fuel cells of the fuel cell system, can be reduced.

According to the invention, it is preferable for the fuel cell system to have a temperature sensor for determining a temperature of the fuel cell. The temperature sensor is preferably arranged on the fuel cell or in a coolant passage, which is configured for the flow of cooling fluid heated by the fuel cells. Preferably, the temperature sensor contacts the fuel cell, for example a wall, a frame, or the like, of the fuel cell. Alternatively or additionally, the coolant temperature at the outlet of the fuel cell stack may also be determined, which is a good approximation of the operating temperature of the fuel cells. Due to the temperature sensor, the operating temperature of the fuel cell can be reliably determined and therefore does not have to be calculated at great expense. This has the operational safety of the fuel cell system is improved with simple means and in a cost-effective manner.

### BRIEF DESCRIPTION OF THE DRAWINGS

A method according to the invention for operating a fuel cell of a fuel cell system for a vehicle and a fuel cell system according to the present invention for a vehicle will be explained in more detail in the following with reference to drawings. Schematically shown are:

FIG. 1 an operating map of fuel cell when operating the fuel cell in accordance with the prior art,

FIG. 2 an operating map of a fuel cell when operating the fuel cell according to a preferred embodiment of the invention,

FIG. 3 in a sectional view, a preferred embodiment of a fuel cell system according to the invention, and

FIG. 4 schematically shows a sequence of a method according to the invention in a preferred embodiment.

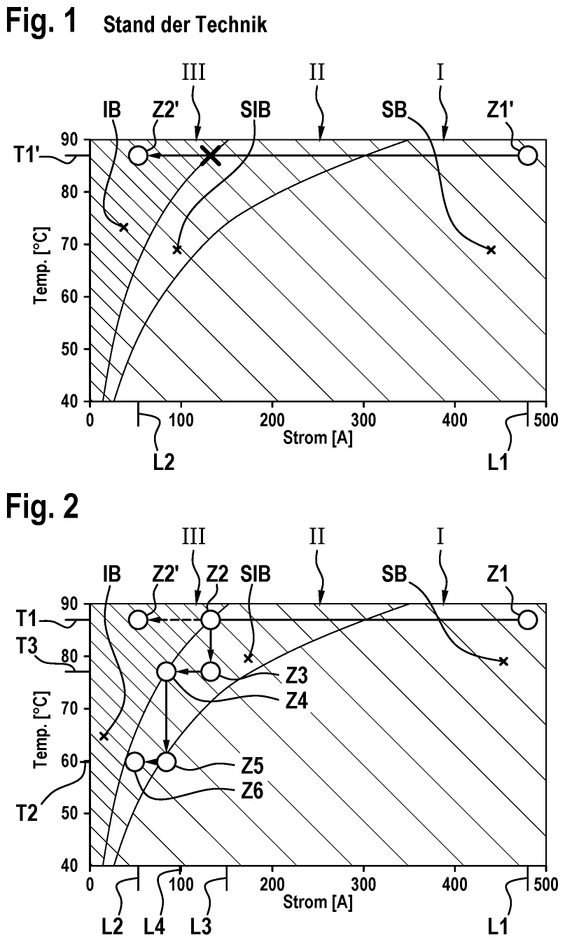

Elements having the same function and mode of action are in each case provided with the same reference signs in FIGS. 1 to 4.

### DETAILED DESCRIPTION

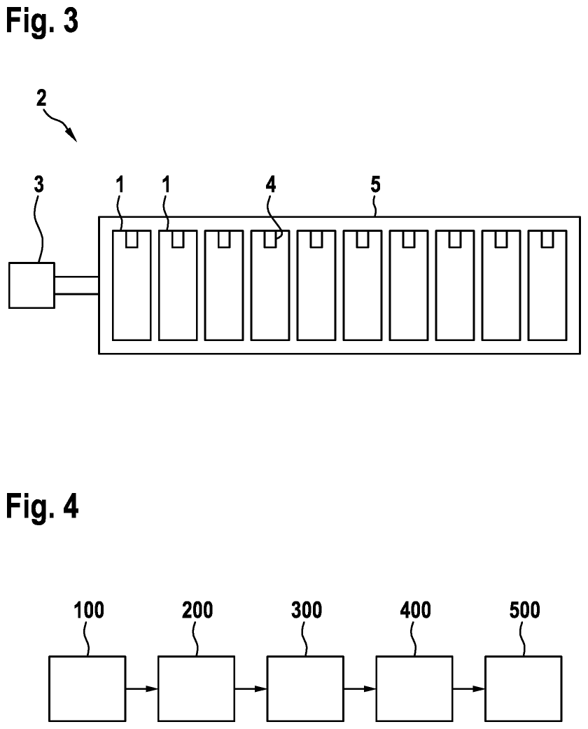

FIG. 1 shows an operating map of a fuel cell 1 (cf. FIG. 3) when operating the fuel cell 1 in accordance with the prior art. The operating map has three operating ranges, a first operating range I for the stationary operating conditions SB, a second operating range II for the stable intermittent operating conditions SIB, and a third operating range III for the unstable operating conditions IB, wherein the third operating range III is to be avoided when operating the fuel cell 1.

In a first operating condition Z1′ of the fuel cell 1, the fuel cell 1 operates with a first load L1 of around 480 A and has a first temperature T1′ of around 87° C. The first operating condition Z1′ is thus a stationary operating condition SB. Due to a reduced load requirement with a second load L2′, the load of the fuel cell 1 is lowered to the second load L2′, such that the fuel cell 1 has a second operating condition Z2′. In a second operating condition Z2′ of the fuel cell 1, the fuel cell 1 operates with the second load L2 of around 50 A and thereby continues to have the first temperature T1′ of around 87° C. As a result, the operating point of the fuel cell 1 is shifted to the third operating range III which is unfavorable for the operation of the fuel cell.

FIG. 2 shows an operating map of a fuel cell 1 operating the fuel cell 1 according to a preferred embodiment of the invention. In a first operating condition Z1 of the fuel cell 1, the fuel cell 1 operates with a first load L1 of around 480 A and has a first temperature T1′ of around 87° C. The first operating condition Z1′ is thus a stationary operating condition SB and corresponds to the first operating condition Z1′ of FIG. 1. Due to a reduced load requirement with a second load L2, the load of the fuel cell 1 is lowered to a third load L3 of around 140 A, such that the fuel cell 1 has a second operating condition Z2 arranged in the second operating area II, such that the fuel cell 1 operates in a stable intermittent operating condition SIB at the limit to the third operating area III. By holding the third load L3, the temperature of the fuel cell 1 falls to a third temperature T3 of around 77° C. In this case, a third operating condition Z3 is achieved, which is also in the second operating area II and again has a greater distance to the third operating area III.

Starting from the third operating condition Z3, the load from the third load L3 is reduced to a fourth load L4 of around 85 A. Here, a fourth operating condition Z4 of the fuel cell 1 is achieved, which is arranged in the second operating area II, such that the fuel cell 1 is operated again in a stable intermittent operating condition SIB at the limit to the third operating area III. By holding the fourth load L4, the temperature of the fuel cell 1 falls to a second temperature T2 of around 60° C. Here, a fifth operating condition Z5 is achieved, which is arranged in the first operating area I, so that the fuel cell 1 is operated again in a stationary operating condition at the limit to the second operating area II.

Starting from the fifth operating condition Z5, the load is lowered further from the fourth load L4 to the second load L2 according to the reduced load requirement. Here, a sixth operating condition Z6 of the fuel cell 1 is achieved, in which the fuel cell 1 is operated at the second load L2 of around 50 A at the second temperature T2 in a stable intermittent operating condition SIB.

In FIG. 3, a preferred embodiment of a fuel cell system 2 according to the invention is schematically depicted in a cross-sectional view. The fuel cell system 2 comprises a plurality of fuel cells 1 which are combined to form a fuel cell stack and arranged in a cell housing 5. A temperature sensor 4 is arranged on the fuel cells 1. Alternatively, a temperature sensor 4 may also be arranged to sense a coolant temperature at a coolant output of the stack. Furthermore, the fuel cell system 2 for controlling the fuel cells 1 comprises a control device 3, which is arranged outside the cell housing 5.

FIG. 4 shows a preferred embodiment of a method according to the invention schematically in a flow chart. In a first method action 100, the fuel cell system 1 is operated by the control device 3 with the first load L1 at the first temperature T1 in a stationary operating condition SB. Thus, the fuel cell 1 has the first operating condition Z1. In a second method action 200, the control device 3 receives a reduced load requirement to operate the fuel cell 1 with a second load L2 that is less than the first load L1.

In a third method action 300, the load of the fuel cell 1 is selectively reduced by the control device 3 from the first load L1 to the third load L3, wherein the third load L3 is greater than the second load L2. The temperature of the fuel cell 1 initially substantially corresponds to the first temperature T1 so that the fuel cell 1 has the second operating condition Z2 and operates in, for example, a stable intermittent operating condition SIB.

Reducing the load of the fuel cell 1 triggers a fourth method action 400, in which the fuel cell 1 cools down to the second temperature T2, at which the fuel cell 1 is operated, for example, in a stationary operating condition SB. When the fuel cell 1 has reached the second temperature T2, the load in a fifth method action 500 is reduced by the control device 3 from the third load L3 to the second load L2. The fuel cell 1 is then operated again, for example, in a stable intermittent operating condition SIB.

1. A method for operating a fuel cell (1) of a fuel cell system (2) for a vehicle, the method comprising:
operating the fuel cell (1) with a first load (L1) at a first temperature (T1) by a control device (3) of the fuel cell system (2),
receiving a load requirement for operating the fuel cell (1) with a second load (L2) by the control device (3), wherein the second load is less than (L2) the first load (L1),
selectively reducing the load of the fuel cell (1) to a third load (L3) by the control device (3), wherein the third load (L3) is less than the first load (L1) and greater than the second load (L2),
cooling the fuel cell (1) to a second temperature (T2), and
reducing the load of the fuel cell (1) to the second load (L2) by the control device (3).

2. The method according to claim 1,
wherein
the fuel cell (1) operates at the first load (L1) and the first temperature (T1) in a stationary operating condition (SB) or a stable intermittent operating condition (SIB).

3. The method according to claim 1,
wherein
such a second load (L2) is received such that the fuel cell (1) would operate at the first temperature (T1) and the second load (L2) in an unstable operating condition (IB).

4. The method according to claim 1,
wherein
selectively reducing the load is carried out in a sudden, gradual or sudden stepwise or gradual stepwise manner.

5. The method according to claim 1,
wherein
selectively reducing the load is carried out such that the fuel cell (1) is operated at least temporarily in a stable intermittent operating condition (SIB) at a transition to an unstable operating condition (IB).

6. The method according to claim 1,
wherein
the fuel cell (1) is operated in a stationary operating condition (SB) or in a stable intermittent operating condition (SIB) upon reaching the second temperature (T2).

7. The method according to claim 1,
wherein
the fuel cell (1) is cooled to a second temperature (T2), such that the fuel cell (1) is operated with the second load (L2) in a stationary operating condition (SB) or in a stable intermittent operating condition (SIB).

8. The method according to claim 1,
wherein
a load difference between the second load (L2) and a higher load with which the fuel cell (1) is operated during performance of the method is used for active cooling of the fuel cell (1).

9. A fuel cell system (2) for a vehicle comprising a fuel cell (1) and a control device (3) for controlling the fuel cell (1),
wherein
the control device (3) is configured to perform a method according to claim 1.

10. The fuel cell system (2) according to claim 9,
wherein
the fuel cell system (2) comprises a temperature sensor (4) for determining a temperature of the fuel cell (1).
